(19) United States
(12) Patent Application Publication
(10) Pub. No.: US 2026/0270345 A1
(43) Pub. Date: Sep. 10, 2026

(54) Methods and systems to navigate multiple IVR systems effortlessly

(71) Applicant: J. Wayne Kullman, Glenview, IL (US)

(72) Inventor: J. Wayne Kullman, Glenview, IL (US)

(21) Appl. No.: 19/074,624

(22) Filed: Mar. 10, 2025

(51) Int. Cl. H04M 3/51

(52) U.S. Cl. CPC H04M 3/5191; H04M 3/5166; H04M 2203/355

(57) ABSTRACT

This invention provides a system and method for seamlessly navigating and bypassing Interactive Voice Response [IVR] interfacing using artificial intelligence, voice recognition, and pre-mapped understanding of IVR pathways. The system comprises an input module for capturing user intent, an engine for interpreting user input, an IVR database storing company-specific IVR mappings, and a dialer module for automated interaction with IVR systems. The invention allows users to input their intent via digital assistant, voice, text, or visual interfaces, automates the dialing and prompt navigation processes, and connects the user directly to the desired representative or department. Additional features include scheduling recurring tasks, fully automated IVR interactions for specific intents, and integration with APIs and web-based systems to enhance functionality. The system reduces user frustration, saves time, and adapts dynamically to changing IVR structures, providing a scalable and accessible solution for streamlining telecommunication interactions.

### FIELD OF THE INVENTION

This invention relates to telecommunications and artificial intelligence, specifically to methods and systems for bypassing Interactive Voice Response (IVR) systems to connect users efficiently with desired representatives or departments.

### AI IVR BYPASS

AI IVR Bypass is a software application designed for mobile and computing devices, enabling users, when calling a company or entity, to bypass automated phone system prompts and navigate directly to desired departments or representatives. By utilizing artificial intelligence, voice recognition, and an interactive visual interface, the system preemptively maps and navigates Interactive Voice Response (IVR) menus to streamline the user experience. For IVRs that allow prompt responses to be entered without listening to the menu of options the AI IVR Bypass will enter the prompt responses in order quickly to speed through the menus.

### BACKGROUND OF THE INVENTION

Modern IVR systems require users to navigate through multiple menu layers, resulting in frustration and inefficiency. This is exacerbated by inconsistent menu designs across companies and user fatigue from repeated calls.

Existing solutions address the issue at an individual company or entity level and do not span all of a user's needs. Unlike these methods, the proposed invention integrates user functions for all IVRs into one place and allows users a consistent and speedy experience across all via one consistent input module that works with a database of pre-mapped IVR menus to dial based on the user's intent.

### SUMMARY OF THE INVENTION

This invention provides an automated system for navigating IVR menus using digital assistants, artificial intelligence, voice commands, and a visual interface. By pre-mapping the IVR menu structure of multiple companies, the system identifies the most efficient path to connect the user to the desired department or representative. Users input their purpose via natural language processing or menu selection, and the system either directly dials the appropriate extension or interacts with the IVR system on the user's behalf.

Additional functionalities include scheduled calls, recurring tasks, and integration with web-based systems to achieve similar objectives.

### DETAILED DESCRIPTION OF THE INVENTION

Purpose: The invention streamlines the process of connecting with specific areas of a company by bypassing traditional IVR menus.

System Architecture:
1. Input Module: Captures user input via voice, text, or touchscreen.
2. IVR Database: Maintains pre-recorded mappings of multiple company IVR structures. The database is updated for changes to previously mapped IVRs and for additions of new IVRs in the background. This may occur manually or by using Artificial Intelligence.
3. Dialer Module: Automates dialing and IVR navigation, including pauses and prompt responses. If the system encounters an error it is reported to the user that the task cannot be completed at this time and the group maintaining the database is notified to correct.
4. Scheduler Module: Captures information for prescheduled activities. In the event of the inventention encountering errors, the user is notified as well as the group maintaining the database.

### HOW TO USE THE INVENTION

Setup:
1. Users install the Smart IVR Bypass application on a device.
2. The system downloads IVR mappings for frequently called companies and entities.
3. Users provide input via voice (“Call the electric company to pay my bill”), text, digital assistant or selection from a menu.
4. The system processes the input, retrieves the IVR path from the database, and places the call entering the premapped appropriate prompt response automatically and without waiting to hear all options.

Example Scenario 1: A user initiates a call by voice command, specifying ‘Call my bank to check my balance.’ The system processes the request, interacts with the bank's IVR system by entering the correct responses to prompts without waiting for the menu of options (as previously mapped and stored), and quickly and audibly provides the balance information.

Example Scenario 2: A user asks the digital assistant on their PDA to talk with service at their phone company. The invention enables the digital assistant to ask why they are calling the phone company. The user responds that they want to talk to buy a new phone. The invention dials the phone company, enters the prompt “1” that indicates they would like to speak in English, then enters the prompt 6 which indicates that they want to talk to sales, then enters the user's phone number as requested by the IVR to know what account. A sales representative answers and the user is able to speak with them significantly faster and easier than current systems allow.

Example Scenario 3: A user sets a schedule in the invention to check their checking account balance, the balance due on their phone bill and the balance due on their electric bill each month on the 15^{th} at 5:00 am. The calls are triggered by the invention on the 15^{th} of each month without interaction from the user. The invention dials the phone number, enters the appropriate prompts to get the information and stores it for the user. When the user awakens they can see the information on within the application.

Example Scenario 4: A user asks the invention, through the digital assistant on their PDA, to pay their electric bill. The invention dials the number and enters the appropriate responses to all prompts within the IVR to pay the balance due. The invention then notifies the user that their bill has been paid from their checking account, as previously set up.

### ADVANTAGES OF THE INVENTION

Eliminates user frustration by automating IVR navigation.
2. Reduces call time by up to 50% through optimized dialing and prompt responses as the invention can enter the appropriate responses to prompts without listening to all menu options.
3. Integrates advanced AI and machine learning to adapt to changing IVR structures.
4. Provides multimodal input options (voice, visual, text), making it accessible to a wide range of users.
5. Creates a user centric application for navigating IVRs of multiple companies and entities consistently from the caller perspective.
6. Allows prescheduling of calls to multiple companies and entities for information or transactions.

### BRIEF DESCRIPTION OF DRAWINGS

### System Architecture Diagram Detail

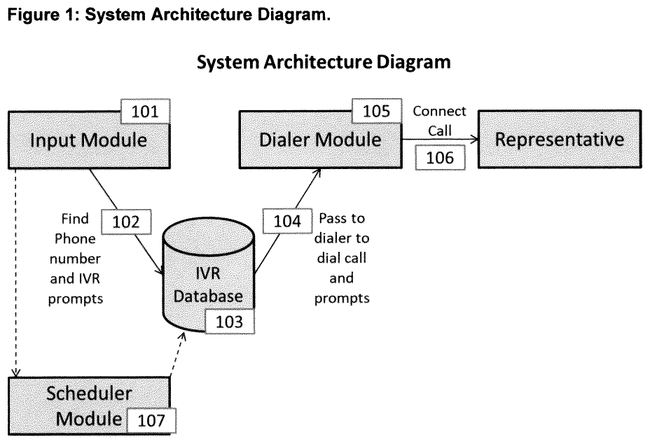

FIG. 1 illustrates the system archictecture, showing the interaction between the modules.

The input module collects information from the user on what they want to accomplish. This includes what company or entity they want to call, what they want to accomplish during the call and any additional information that may be required by the IVR of the company or entity.

The input module communicates with the IVR database by sending a query for the information necessary to achieve the user's intent.

The IVR database holds information on how the IVRs work for multiple companies and entities. Information that has been previously mapped is stored that maps how to communicate with the IVR to achieve various user intents. For example, the data base stores the path a caller must take to pay a bill. This path may the number for the company and a series of 1 digit IVR prompt responses to achieve the intent. In other variations this may be accomplished by mapping the direct number for the intent, through APIs or website commands.

The IVR passes the instructions to the dialer module. For example, the user's intent is reached by dialing the company phone number and responding to several prompts. This may be passed to the dialer as 18005551212,1,2,1.

The dialer module dials the numbers passed to it. In the previous example it dials the number provided which call the company respond 1 to the first prompt, 2 to the second prompt and 1 to the third prompt. The invention interacts directly with the IVR on behalf of the user

The user is connected directly with the area they requested. In another variation the user may not be required to interact with a person at all. In the case of fully automated IVR activities such as “pay my bill”, the invention can include all of the prompts required to do so and complete the desired transaction entirely with no interaction required of the user.

The optional scheduler can be used to preschedule or make recurring calls. The input module passes the information on what calls to make with what intent at what date and time to the scheduler module. At the prescribed date and time the scheduler module collects the correct triggers the calls through the IVR Database and Dialer Module. In one example the user may ask the invention to call their bank at 5:00 am on the 15^{th} of each month to check their balance. The scheduler module stores the information and trigger the call on the 15^{th} of each month. The IVR Database passes the phone number and each prompt to get through the fully automated call and obtain the current balance. The balance is then saved and reported back to the user through the input module. At whatever time the user opens the application they can review their balance. In another variation the invention could have also checked the balance due on the user's credit card through the scheduler module. The input module will report the current checking balance and balance due on the credit card and ask the user if it can pay the credit card. If the user responds yes, this triggers a fully automated interaction between the invention and the credit card company where they invention pays the bill through the IVR requiring not user interaction.

### OPERATIONAL FLOW CHART DETAIL

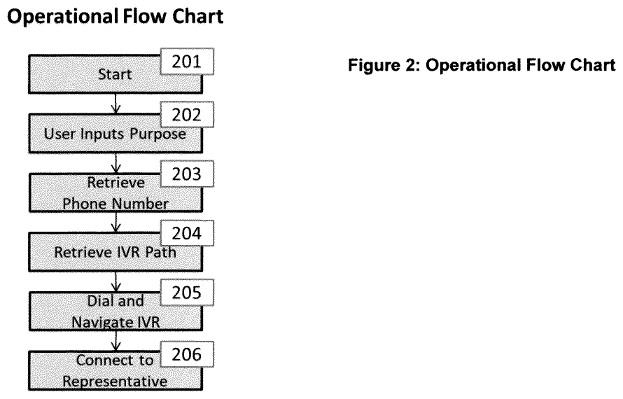

FIG. 2 presents the operational workflow for automating placing a call through the invention.

The user initiates the application. This can be accomplish through a digital assistant or application.

The user inputs the purpose of the interaction. For example, the user might say “I want to pay my electric bill”. In other variations they may choose the company they wish to call and are prompted to input their intent from the call. This can be accomplished visually, audibly or through haptic interaction.

The invention retrieves the phone number to be dialed. In another variation the phone number or an API for directly connecting to the appropriate area of the company or entity may be previously mapped and dialed directly, skipping step 204.

The invention retrieves the appropriate path through the IVR to achieve their intent as previously mapped and stored for this purpose.

The application dials the appropriate number and enters the appropriate prompts to achieve the user's intent. In another variation the invention may be able to achieve the user's intent without requiring further interaction on the part of the user. The IVR may be fully automated and the invention can interact directly with it to achieve the intent.

The user is connected to the appropriate representative as previously mapped by the invention

1) A method for navigating and bypassing IVR systems, comprising:
a) Creating, maintaining and accessing a database of pre-mapped IVR structures
b) Capturing user input through a digital assistant, voice, text, or a visual interface
c) Using artificial intelligence to match user intent with IVR paths
d) Automating dialing and navigation through the IVR system to connect the user to a target representative or department
e) Ability for the system to dial, navigate IVR menus and complete tasks on behalf of the user.

2) A system for Al-based IVR navigation, comprising:
a) An input module for capturing user inputs
b) An IVR database storing pre-mapped company IVR structures
c) An Al engine for interpreting user intent and generating navigation paths
d) A dialer module for executing calls and interacting with IVR prompts
e) A Scheduler module for scheduling recurring or one time calls in the future
f) A method for interacting with external systems, including websites, to perform user-specified tasks using pre-mapped processes.
